(19) United States
(12) Patent Application Publication
(10) Pub. No.: US 2011/0300829 A1
(43) Pub. Date: Dec. 8, 2011

(54) FINGERPRINT ACTIVATED QUICK FUNCTION SELECTION

(75) Inventors: Juha H. Nurmi, Salo (FI); Kaj Saarinen, Tokyo (JP); Tero Rautanen, Turku (FI)

(73) Assignee: NOKIA CORPORATION, Espoo (FI)

(21) Appl. No.: 12/299,481

(22) PCT Filed: Jun. 9, 2006
(86) PCT No.: PCT/EP2006/005525

§ 371 Date: Jun. 23, 2009

(51) Int. Cl. H04W 12/08; G08B 29/00

(52) U.S. Cl. 455/411; 340/5.53

(57) ABSTRACT

A device such as a laptop computer includes a fingerprint sensor and has a specific function to be performed associated with at least two of the fingerprints of an authorized user of the device. The device performs the specific function when an authorized user places a finger on the fingerprint sensor. The functions associated with the fingerprints of the authorized users can be quickly accessed even when a security or keyboard lock is active. A mobile communication terminal includes a fingerprint sensor in a call handling key. Calls are answered, rejected or initiated when an authorized user places a finger on the fingerprint sensor.

### CROSS REFERENCE TO RELATED APPLICATIONS

This application is the National Stage of International Application No. PCT/EP2006/005525, International Filing Date, 9 Jun. 2006, which designated the United States of America, and which International Application was published under PCT Article 21 (2) as WO Publication No. WO2007/140806 the disclosure of which is incorporated herein by reference in its entirety.

### BACKGROUND

1. Field

The disclosed embodiments relate to devices in which functions are activated by user input, in particular to devices in which user input is performed with a fingerprint sensor. The disclosed embodiments relate to a method of quickly selecting or activating a function in a device, in particular in a device the operation of which is controlled by a processor.

2. Brief Description of Related Developments

It is known to use fingerprint sensors on personal computers and on mobile handsets, in particular to enable secure access (authentication) for a number of users based on a fingerprint. Hereto, a database connected to the fingerprint sensor contains information relating to authorized users by means of fingerprint data.

Most personal computers and mobile handsets are provided with a security lock (or just a keypad lock “keylock”) function, i.e. a state of the device in which the processor will ignore any key activations, except those that deactivate the lock function.

Many personal computers and telephone headsets are also provided with quick access keys (shortcuts) by means of which a user can activate a specific function associated with a given quick access key by a single press of the key.

However, a problem associated with the security or keypad lock function is that it has to be opened first before any quick selection can be done with the quick access keys. This slows down quick selection and thereby undermines the concept of quick selection keys.

In most mobile handsets the keylock function is deactivated for the “call answer key” in order to enable a user to easily answer an incoming call even if the keylock is active. However, a problem associated with this way of handling keylock on a mobile handset is that incoming calls may also be answered either by accident (when phone is in a pocket for example) or intentionally by an unauthorized third-person should they get access to the handset.

### SUMMARY

On this background, it is an aspect of the disclosed embodiments to provide a device, which allows quick selection of functions when a keylock is active. This aspect is achieved by providing a device comprising a processor controlling the operation of the device, the processor is configured to perform a multitude of functions, a fingerprint sensor for scanning a fingerprint of a user, a memory in which the fingerprints of at least two different fingers of one and the same user are stored, a specific function to be performed being associated with each of the at least two fingerprints, and the processor being configured to perform the function associated with a fingerprint when the fingerprint scanned by the fingerprint sensor matches one of the stored fingerprints.

Since the human hand normally has 10 fingers, each having a different print, up to ten different functions can be activated quickly with the fingerprint sensor. Further, only a single sensor is required for activating up to 10 different quick selection functions, where conventionally up to ten keys were required. Thus, the size of the user interface can be reduced.

The specific function can be the start of an application or of an applet on the device.

Preferably, the device further comprises a keypad, in which case the device has at least one mode in which a security lock or a keylock is applied, and the processor is configured to perform the command associated with a given fingerprint when the fingerprint sensor scans the given fingerprint, also when the device is in a mode in which the security lock or keylock is active.

The device may comprise one or more further fingerprint sensors, in which case a specific function to be performed is associated with each of the at least two fingerprints and the further fingerprint sensor. Thus, an increased number quick selection functions can be activated

The fingerprint data of one or more authorized users can be stored in the device to support multi-user operation.

It is also an aspect of the disclosed embodiments that the device is coupled to a secure network.

It is another aspect of the disclosed embodiments to provide an automated teller machine including the device.

An aspect above is also achieved by providing a method for operating a device with a user interface that includes a fingerprint sensor comprising associating a specific function to be performed with each of at least two fingers of a user, and performing the specific function associated with a finger when the fingerprint sensor scans a fingerprint matching one of the at least two fingers.

Preferably, the device is controlled by a processor operating in response to user input via a keyboard, further comprising the step of performing the specific function associated with a fingerprint when the fingerprint sensor scans a fingerprint matching one of the at least two fingers when a security lock or keypad lock is active. Thus, the user does not waste time to unlock the device when trying to activate a quick selection function.

The method may further comprise the step of storing fingerprint data of one or more authorized users of the device. Thus, the device can be used in a multi-user environment.

The step of performing a function may include performing an application or an applet.

It is another aspect of the disclosed embodiments to provide a mobile communication terminal in which the risk of inadvertedly answering a call is reduced. This aspect is achieved by providing a mobile communication terminal comprising a processor controlling the operation of the terminal, a fingerprint sensor for scanning a fingerprint of a user of the terminal, the processor being configured to answer an incoming call when a fingerprint scanned by the fingerprint sensor matches a stored fingerprint during an incoming call, and/or the processor being configured to initiate an outgoing call when a fingerprint scanned by the fingerprint sensor matches a stored fingerprint and a telephone number has been keyed in, selected or identified.

Thus, an authorized user can quickly answer or place a call, with a minimized risk of inadverted call initiations, -answers or -rejections. This will improve confidence of users in the device and thereby the acceptance of the technology.

Preferably, the fingerprint sensor is integrated in a combined onhook/offhook key, in a separate onhook key and/or in a separate offhook key.

Alternatively, the fingerprint sensor can be integrated in a multifunctional softkey.

The mobile communication terminal may have at least one mode of operation or state in which a keylock is applied and wherein the processor is configured to answer an incoming call when a fingerprint scanned by the fingerprint sensor matches a stored fingerprint during an incoming call, also when the device is in a mode in which the keypad lock is active, and/or wherein the processor is configured to initiate an outgoing call when a fingerprint scanned by the fingerprint sensor matches a stored fingerprint when a telephone number has been keyed in, selected or identified, also when the device is in a mode in which the keypad lock is active.

The fingerprint data of one or more authorized users may be stored in the terminal to support multi-user operation.

An aspect above is also achieved by providing a method for operating a mobile communication terminal device with a user interface that includes a fingerprint sensor, comprising answering an incoming call when a fingerprint scanned by the fingerprint sensor matches a stored fingerprint during an incoming call, and/or initiating an outgoing call when a fingerprint scanned by the fingerprint sensor matches a stored fingerprint and a telephone number has been keyed in, selected or identified.

Preferably, the fingerprint sensor is integrated in a combined onhook/offhook key, in a separate onhook key, in a separate off hook key and/or in a multifunctional softkey

The device may be controlled by a processor operating in response to user input via a keyboard, further comprising the step of performing the specific function associated with a finger when the fingerprint sensor scans a fingerprint matching one of the at least two fingers when a security lock or keypad lock is active.

Further aspects, features, advantages and properties of the device, mobile communication terminal and methods according to the disclosed embodiments will become apparent from the detailed description.

### BRIEF DESCRIPTION OF THE DRAWINGS

In the following detailed portion of the present description, the disclosed embodiments will be explained in more detail with reference to the exemplary embodiments shown in the drawings, in which:

FIG. 1 is a diagrammatic front view on a device according to a first embodiment,

FIG. 2 is a block diagram illustrating the general architecture of the device of FIG. 1,

FIG. 2A is a flow chart illustrating the operation of the device shown in FIG. 1

FIG. 3 is an elevated view on a device according to a second embodiment,

FIG. 4 is a diagrammatic elevated view on the device according to FIG. 3, and

FIG. 5 is a diagrammatic front view on a device according to a third embodiment.

### DETAILED DESCRIPTION OF THE DRAWINGS

In the following detailed description, the device and the method according to the disclosed embodiments in the form of a personal computer, PDA, mobile terminal or a mobile communication terminal in the form of a cellular/mobile phone, will be described by the preferred embodiments. The disclosed embodiments can, however, also be carried out with any other device the operation of which controlled by a processor.

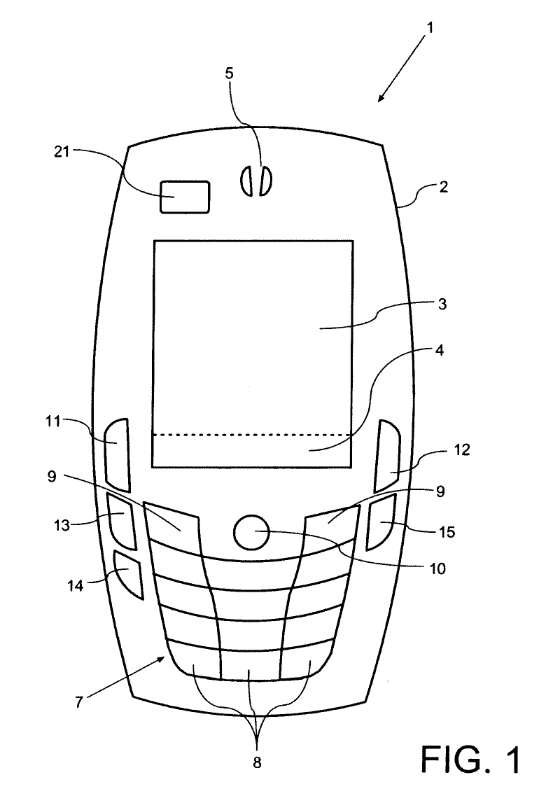

FIG. 1 illustrates a first embodiment of a mobile terminal according to the disclosed embodiments in the form of a mobile telephone by a front view. The mobile phone 1 comprises a user interface having a housing 2, a display 3, an on/off button (not shown), a speaker 5 (only the openings are shown), and a microphone 6 (not visible in FIG. 1). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 7 has additionally a second group of keys comprising two softkeys 9, two call handling keys (offhook key 11 and onhook key 12), and a 5-way navigation key 10 (up, down, left, right and center: select/activate). The function of the softkeys 9 depends on the state of the phone, and navigation in the menu is performed by using the navigation-key. The present function of the softkeys 9 is shown in separate fields (soft labels) in a dedicated area 4 of the display 3, just above the softkeys 9. The two call handling keys 11,12 are used for establishing a call or a conference call, terminating a call or rejecting an incoming call. This key layout is characteristic for e.g. the Nokia 6600™ phone.

The navigation key 10 is a four- or five-way key which can be used for cursor movement, scrolling and selecting (five-way key) and is placed centrally on the front surface of the phone between the display 3 and the group of alphanumeric keys 7. A dedicated menu key 13 gives direct access to the menu structure and a copy and paste key 14 assist in collaboration with the softkeys in copying and pasting text or graphics. A dedicated clear key 15 serves to delete items.

A fingerprint sensor 21 is placed at an easily accessible position on the housing. In the present embodiment the sensor is shown to be placed on the front surface of the mobile communication terminal. However, the fingerprint sensor could be placed on other surfaces of the terminal, such as the sides, top, bottom or back.

A releasable rear cover (not shown) gives access to the SIM card (not shown), and the battery pack (not shown) in the back of the phone that supplies electrical power for the electronic components of the mobile phone 1.

The mobile phone 1 has a flat display 3 that is typically made of an LCD with optional back lighting, such as a TFT matrix capable of displaying color images. A touch screen (not shown) may be applied on top of the LCD display 3.

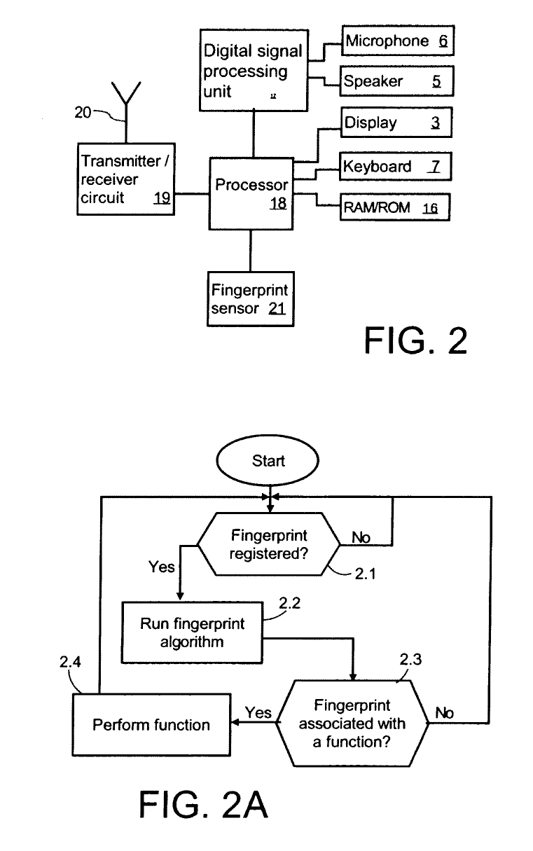

FIG. 2 illustrates in block diagram form the general architecture of a mobile phone 1 constructed in accordance with the disclosed embodiments. A processor 18 controls the communication with the cellular network via the transmitter/receiver circuit 19 and an internal antenna 20. A microphone 6 transforms the user's speech into analogue signals, the analogue signals formed thereby are A/D converted in an A/D converter (not shown) before the speech is encoded in a digital signal processing unit 17 (DSP). The encoded speech signal is transferred to the processor 18, which e.g. supports the GSM terminal software. The processor 18 also forms the interface to the peripheral units of the apparatus, including a RAM memory and a ROM or Flash ROM memory 16, the graphical display 3, the fingerprint sensor 21 and keypad 7 (as well as data, power supply, etc.). The digital signal-processing unit 17 speech-decodes the signal, which is transferred from the processor 18 to the speaker 5 via a D/A converter (not shown).

As is also illustrated in the flowchart in FIG. 2A, after a fingerprint is registered by the fingerprint sensor 21, the signal from the fingerprint sensor is processed with a fingerprint algorithm that is either included in the hardware of the sensor 21 or in the software running on the processor 18. A variety of fingerprint processing algorithms have been developed and experimented with over the years, each with a varying degree of success. The basic idea behind all of these algorithms is to identify and locate unique points of the fingerprint referred to as minutia. The two predominant types of minutia are ridge endings and bifurcations. A ridge ending is formed when a ridge of a fingerprint no longer continues along its path, it simply stops or ends. A bifurcation on the other hand is formed when a ridge of a fingerprint splits (bifurcates) into two ridges or, conversely, when two ridges merge into one ridge. Fingerprint identification algorithms are concerned with identifying every minutia of the fingerprint (both ridge endings and bifurcations) and associating with each minutia found, three positional identifiers (x, y, and theta). These three parameters locate the minutia in an arbitrary (but fixed) Cartesian coordinate system where x and y map the position of the minutia and theta defines its angle of orientation with respect to one of the axes. A match between two fingerprints is made when the x, y, and theta of one fingerprint match (or nearly match) the x, y, and theta of another print. Various other known fingerprint identification algorithms can be used for the disclosed embodiments, and since the exact nature of the fingerprint identification algorithm is not essential for the disclosed embodiments, these other algorithms are not described in detail here.

The fingerprint data of at least two of the fingers of an authorized user (such as for example the owner of the terminal) have been stored in the terminal 1. The stored fingerprint data can have been generated with the fingerprint sensor 21 on the terminal itself, or be transmitted/downloaded to the terminal from another source. A function to be performed is associated with each of the at least two fingerprints of the user. The association of functions to the various fingerprints is in this preferred embodiment carried out via the user interface, but the functions may alternatively be preprogrammed. A group of functions to choose from may be preselected. The functions to be performed can be simple functions, applets, or applications.

The fingerprint sensor 21 scans the fingerprint of any finger that is placed thereon (step 2.1). The processor 18 monitors the output from the fingerprint sensor 21 and compares it with the stored fingerprint data using the fingerprint algorithm (step 2.2 and 2.3). When there is a match, the processor 18 performs the function associated with the fingerprint that has been scanned by the fingerprint sensor (step 2.4), such as for example starting an internet browser, creating a new message, accessing the calendar, placing a call to a given contact and unlocking the terminal. If there is no match the process returns to step 2.1.

A specific function can be associated with each of the 10 fingers of the human hands. Table 1 below provides an example of association between fingers of the right hand (RH) and the left hand (LH) and functions to be performed according to the disclosed embodiments.

TABLE 1

| Finger | Function to be performed |
|---|---|
| RH thumb | New message |
| RH index finger | Access to calendar |
| RH middle finger | Unlock the terminal |
| RH ring finger | Initiate phone call to contact 1 |
| RH little finger | Initiate phone call to contact 2 |
| LH thumb | Open Web browser |
| LH index finger | Unlock the terminal |
| LH middle finger | Initiate phone call to contact 3 |
| LH ring finger | Initiate phone call to contact 4 |
| LH little finger | Initiate phone call to contact 5 |

The terminal is provided with a keylock that prevents actions of the terminal in response to inadverted key activations, for example when the terminal is in a bag or pocket. When the keylock is active, the processor ignores any key activations, except those to deactivate the keylock (if any), in some circumstances particular keys can be enabled to bypass the keylock, such as the call handling keys upon an incoming call. The functions activated with the fingerprint sensor are performed also when the keylock is active, i.e. the user only has to place the correct finger on the fingerprint sensor to have the terminal (processor 18) perform the function associated with the fingerprint concerned. According to a variation of this embodiment the terminal is not provided with a keylock.

According to another variation of the first and second embodiments one or more further fingerprint sensors (not shown) are provided to increase the number of functions that can be accessed quickly.

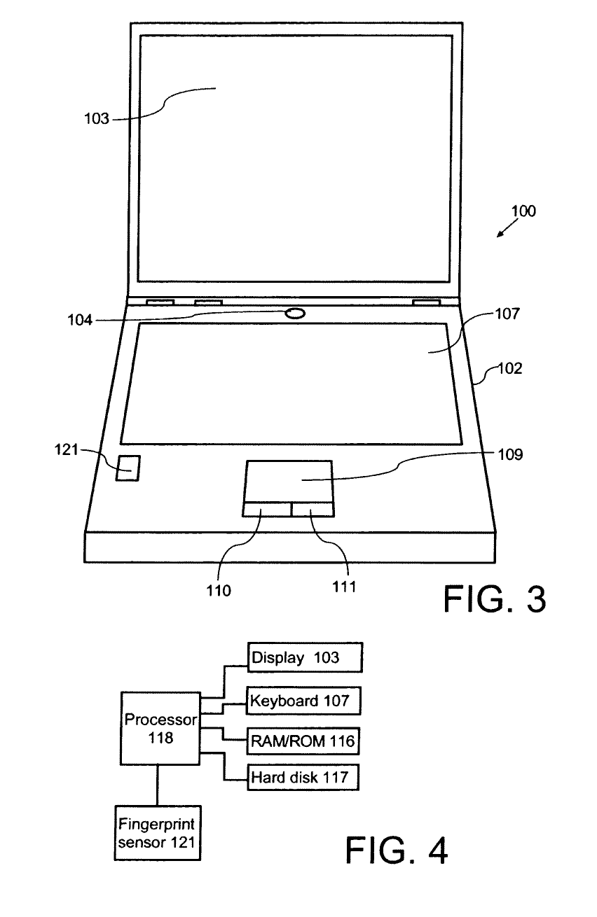

FIG. 3. shows a second embodiment in the form of a laptop computer. The laptop computer 100 comprises a user interface having a housing 102, a display 103, and an on/off button 104. The laptop computer 100 according to the first preferred embodiment is adapted for operation with Windows® operating system, but could just as well be operated with any other suitable operating system such as Mac OS X® or Linux®. The laptop computer 100 may be connected to a TCP/IP-based network, although this is not necessary for the disclosed embodiments.

The keyboard 107 is of the “QWERTY” or similar type and has alphabetic keys and numeric keys, by means of which the user can enter text and numbers.

The laptop computer 100 has additionally a touchpad 109, a leftclick button 110 and a rightclick button 111. The touchpad 109 serves to control the position of a cursor of the graphical user interface on the display 103. The leftclick and rightclick keys 110 and 111 serve to select and activate functions associated with icons shown on the display 103. These functions can be simple functions that are performed as a part of an application, such as marking a text, the changing of a setting, but they can also be the start of applets or applications.

A fingerprint sensor 121 is placed at an easily accessible position on the housing 102. In the present embodiment the fingerprint sensor 121 is shown to be placed on the front surface of the laptop computer 100. However, the fingerprint sensor 121 could be placed on other surfaces of the computer, such as the sides, top, bottom or back.

A releasable rear cover (not shown) gives access to the battery pack (not shown) in the back of the computer that supplies electrical power for the electronic components of the laptop computer 100.

The laptop computer 100 has a pivotable flat display 103 that is typically made of an LCD with back lighting, such as a TFT matrix capable of displaying color images.

FIG. 4 illustrates in block diagram form the general architecture of a laptop computer 100 constructed in accordance with the disclosed embodiments. A processor 118 controls the operation of the computer. The processor 118 also forms the interface to the peripheral units of the apparatus, including a RAM memory and ROM memory 116, the hard disk 117, the graphical display 103, the fingerprint sensor 121, touchpad 109 and keyboard 107 (as well as data, power supply, etc.).

The signal from the fingerprint sensor 121 is processed with a fingerprint algorithm that is either included in the hardware of the sensor 121 or in the software running on the processor 118. Similar fingerprint identification algorithms as described above for the first embodiment can be used for the second embodiment and since the exact nature of the usable fingerprint identification algorithm is not essential for the disclosed embodiments, these algorithms are not described in detail here.

The fingerprint data of at least two of the fingers of an authorized user (such as for example the owner of the terminal) have been stored in the terminal 100, for example on the hard disk 117. The stored fingerprint data can have been generated with the fingerprint sensor 121 on the terminal 100 itself, or be transmitted/downloaded to the terminal from another source.

A function to be performed is associated with each of the at least two fingerprints of the user. The association of functions to the various fingerprints is in this preferred embodiment carried out via the graphical user interface, but the functions may alternatively be pre-programmed. A group of functions to choose from may be preselected. The functions to be performed can be simple functions, applets, or applications.

The fingerprint sensor 121 scans the fingerprint of any finger that is placed thereon. The processor 118 monitors the output from the fingerprint sensor 121 and compares it with the stored fingerprint data using the fingerprint algorithm. When there is a match the processor 118 performs the function associated with the fingerprint that has been scanned by the fingerprint sensor 121, such as for example starting an internet browser, creating a new e-mail message, accessing the calendar, opening a file or unlocking the computer 100.

A specific function can be associated with each of the 10 fingers of the human hands. Table 2 below provides an example of association between fingers of the right hand (RH) and the left hand (LH) and functions to be performed according to the disclosed embodiments.

TABLE 2

| Finger | Function to be performed |
|---|---|
| RH thumb | New e-mail |
| RH index finger | Access to calendar |
| RH middle finger | Unlock the computer |
| RH ring finger | Start wordprocessor |
| RH little finger | Start softphone |
| LH thumb | Open Web browser |
| LH index finger | Unlock the computer |
| LH middle finger | Initiate phone call to contact |
| | 1 with the softphone |
| LH ring finger | Start photo viewer |
| LH little finger | Lock the computer |

The computer 100 is provided with a safety lock that prevents actions of the computer in response to inadverted or unauthorized key activations. When the safety lock is active, the processor only allows the entry of a password and does not allow any other user interaction with the computer. The functions activated with the fingerprint sensor are performed also while the computer is locked, i.e. the user only has to place the correct finger on the fingerprint sensor 121 to have the computer (processor 118) perform the function associated with the fingerprint concerned.

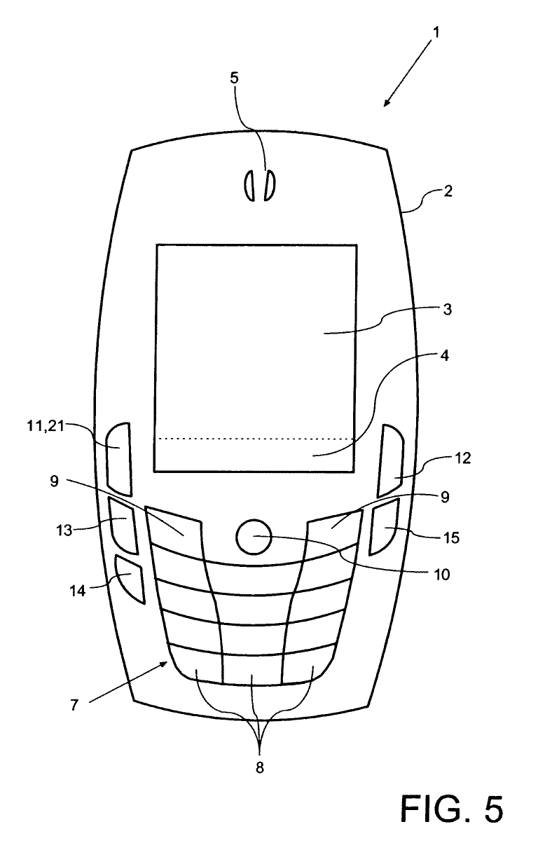

FIG. 5 shows a third embodiment, which is a mobile communication terminal 1 that is substantially identical to the mobile communication terminal according the first embodiment. However, the fingerprint sensor 21 is integrated in the offhook key 11.

In this embodiment the main use of the fingerprint sensor 21 is to answer an incoming call and/or to initiate an outgoing call. Only the fingerprint data of one finger per authorized user need to be stored in the terminal 1 according to this embodiment. The processor 18 monitors the signal from the fingerprint sensor 21 and compares it with the stored fingerprint data. When the processor 18 detects an incoming call and a fingerprint match simultaneously, the incoming call is answered. When the processor 18 detects that a telephone number has been entered, selected or otherwise identified and a fingerprint match occurs simultaneously an outgoing call to the identified phone number is placed.

The keylock function of the terminal can be active when a call is answered or initiated using the fingerprint sensor 21. Thus, the risk of a call inadvertedly being answered or initiated is significantly reduced when the keylock function is active and the only way to answer or initiate a call is by a fingerprint match.

According to a variation of the third embodiment a second fingerprint sensor (not shown) is integrated in the onhook key 12, to avoid unintended rejections of incoming calls.

According to a further embodiment (not shown) the system with the multiple fingertip and function association is used in an ATM (automated teller machine) cash dispenser or other terminal to gain access to banking related functions, e.g. a terminal that is connected to a secure network. A plurality of fingerprints of at least two different fingers of an authorized user are stored in a computer system coupled to the ATM. The user interface of the ATM is provided with a fingerprint sensor and a processor in the computer system coupled to the ATM is configured to perform the specific function associated with the finger concerned when a fingerprint has been recognized and authenticated.

The embodiments described above can be combined with one another in arbitrary combinations.

The term “comprising” as used in the claims does not exclude other elements or steps. The term “a” or “an” as used in the claims does not exclude a plurality. The single processor or other unit may fulfill the functions of several means recited in the claims.

Although the disclosed embodiments have been described in detail for purpose of illustration, it is understood that such detail is solely for that purpose, and variations can be made therein by those skilled in the art without departing from the scope of the disclosed embodiments.

1. A device comprising:
a processor controlling the operation of the device, said processor is configured to perform a multitude of functions,
a fingerprint sensor for scanning a fingerprint of a user,
a memory in which the fingerprints of at least two different fingers of one and the same user are stored,
a specific function to be performed being associated with each of said at least two fingerprints, and
said processor being configured to perform the function associated with a fingerprint when the fingerprint scanned by the fingerprint sensor matches one of the stored fingerprints.

2. A device according to claim 1 wherein said specific function is to start an application or an applet on the device.

3. A device according to claim 1, further comprising a keypad or keyboard, wherein said device has at least one mode of operation in which a security lock or keylock is active and wherein said processor is configured to perform the command associated with a given fingerprint when said fingerprint sensor scans said given fingerprint also when the device is in a mode in which the security lock or keylock is active.

4. A device according to claim 1, comprising one or more further fingerprint sensors, wherein a specific function to be performed is associated with each of said at least two fingerprints and said further fingerprint sensor.

5. A device according to claim 1, in which fingerprint data of one or more authorized users are stored.

6. A device according to claim 1 that is coupled to a secure network.

7. An automated teller machine, comprising a device according to claim 1.

8. A method for operating a device with a user interface that includes a fingerprint sensor, comprising:
associating a specific function to be performed with each of at least two fingers of a user, and
performing the specific function associated with a fingerprint when the fingerprint sensor scans a fingerprint matching one of said at least two fingers.

9. A method according to claim 8, wherein said device is controlled by a processor operating in response to user input via a keyboard, further comprising the step of performing the specific function associated with a fingerprint when the fingerprint sensor scans a fingerprint matching one of said at least two fingers when a security lock or keypad lock is active.

10. A method according to claim 8, further comprising the step of storing fingerprint data of one or more authorized users of the device.

11. A method according to claim 8, wherein said step of performing a function includes performing an application or an applet.

12. A mobile communication terminal comprising:
a processor controlling the operation of the terminal,
a fingerprint sensor for scanning a fingerprint of a user of the terminal,
said processor being configured to answer an incoming call when a fingerprint scanned by the fingerprint sensor matches a stored fingerprint during an incoming call, and/or
said processor being configured to initiate an outgoing call when a fingerprint scanned by the fingerprint sensor matches a stored fingerprint and a telephone number has been keyed in, selected or identified.

13. A mobile communication terminal according to claim 12, wherein said fingerprint sensor is integrated in a combined onhook/offhook key, in a separate onhook key and/or in a separate offhook key.

14. A mobile communication terminal according to claim 12, wherein said fingerprint sensor is integrated in a multifunctional softkey.

15. A mobile communication terminal according to claim 12, wherein said mobile communication terminal has at least one mode of operation or state in which a keylock is applied and wherein said processor is configured to answer an incoming call when a fingerprint scanned by the fingerprint sensor matches a stored fingerprint during an incoming call, also when the device is in a mode in which the keypad lock is active, and/or wherein said processor is configured to initiate an outgoing call when a fingerprint scanned by the fingerprint sensor matches a stored fingerprint when a telephone number has been keyed in, selected or identified, also when the device is in a mode in which the keypad lock is active.

16. A mobile communication terminal according to claim 12, wherein fingerprint data of one or more authorized users are stored.

17. A method for operating a mobile communication terminal device with a user interface that includes a fingerprint sensor, comprising:
answering an incoming call when a fingerprint scanned by the fingerprint sensor matches a stored fingerprint during an incoming call, and/or
initiating an outgoing call when a fingerprint scanned by the fingerprint sensor matches a stored fingerprint and a telephone number has been keyed in, selected or identified.

18. A method according to claim 17, wherein said fingerprint sensor is integrated in a combined onhook/offhook key, in a separate onhook key, in a separate off hook key and/or in a multifunctional softkey

19. A method according to claim 17, wherein said device is controlled by a processor operating in response to user input via a keyboard, further comprising the step of performing the specific function associated with a fingerprint when the fingerprint sensor scans a fingerprint matching one of said at least two fingers when a security lock or keypad lock is active.
